(19) United States
(12) Patent Application Publication
(10) Pub. No.: US 2007/0095454 A1
(43) Pub. Date: May 3, 2007

(54) Ultrasonic joining of polymer mats to mechanical devices including electric appliances

(76) Inventors: Allen L. Panther, Newark, OH (US); Jerry M. Parks, Granville, OH (US)

Correspondence Address: OWENS CORNING, 2790 COLUMBUS ROAD, GRANVILLE, OH, 43023, US

(21) Appl. No.: 10/932,821

(22) Filed: Sep. 2, 2004

(51) Int. Cl. B32B 37/00

(52) U.S. Cl. 156/73.1

(57) ABSTRACT

A method is provided for securing a polymer blanket to a mechanical device. The method includes positioning the polymer blanket against a polymer surface of the mechanical device and ultrasonically joining the polymer blanket to that surface. The invention also relates to a mechanical device including a mechanical component and a polymer insulator ultrasonically joined to a polymer wall of the mechanical device and at least partially enclosing the mechanical component.

### TECHNICAL FIELD AND INDUSTRIAL APPLICABILITY OF THE INVENTION

The present invention relates generally to thermal and/or acoustical insulation technology and, more particularly, to a method of securing a polymer blanket to a polymer surface of a mechanical device including electrical appliances such as a dishwasher as well as to mechanical devices incorporating a polymer blanket attached in such a manner.

### BACKGROUND OF THE INVENTION

Automatic dishwashers have long been known as a particularly convenient and efficient way to clean dishes following their use. Such dishwashers generally include a washing chamber or tub constructed from a polymer material for holding the dishes and one or more streams of pressurized fluid for washing food and drink residue from those dishes. Unfortunately, the washing process generates considerable heat during hot water washing and considerable noise at all times. Both can be quite annoying to the user. In an effort to reduce this heat and noise it has long been known to provide dishwashers with thermal and/or acoustical insulation.

Conventional acoustical insulation systems for dishwashers generally comprise sound transmission barriers and sound absorption layers. Typically acoustical insulation involves enclosing the noise source in an insulation structure. A typical form of acoustical insulation is a layer of mineral fiber insulation, such as fiberglass insulation, wrapped around or positioned around the source of unwanted noise. For example, an insulator or blanket is usually secured to the tub of the dishwasher to absorb sound energy and thereby reduce transmission of unwanted sound from the source of the sound in the dishwasher. Such an insulator also possesses thermal insulating properties.

In the past the insulator has been secured to the tub of the dishwasher in one of two ways: either by an adhesive or mechanical means. Adhesives used are typically a tape or a strip of pressure sensitive hot melt. Mechanical attachments are typically in the form of metal clips or barbed plastic fasteners commonly referred to as “Christmas trees”. While adhesives and mechanical fasteners both provide the desired function, they are not without their disadvantages. The use of adhesives involves the waste of release liners, core tubes and other packaging materials. The use of mechanical fasteners involves an additional manufacturing process to produce the fasteners and added production time for their installation and use. In brief, both of the prior art approaches suffer certain shortcomings.

The present invention relates to a new method for securing an insulator, such as a polymer blanket, to a polymer surface of a mechanical device including electrical appliances such as a dishwasher by means of ultrasonic joining. Advantageously, the new method provides for a reliable and dependable connection between the insulator/polymer blanket and the polymer surface of the mechanical device while eliminating the waste associated with the use of adhesives and the manufacturing time and expense associated with the use of mechanical fasteners.

### SUMMARY OF THE INVENTION

In accordance with the purposes of the present invention as described herein, a method is provided for securing a polymer blanket to a polymer surface of a mechanical device. The method comprises positioning the polymer blanket against a polymer surface of the mechanical device and ultrasonically joining the polymer blanket to that surface. This includes completing the ultrasonic joining at a frequency of between about 20 to about 40 kHz and a pressure of, for example, between about 35 and about 65 psi. The ultrasonic joining may be done, for example, by welding, staking or inserting.

In accordance with yet another aspect of the present invention a method is provided for insulating an electrical appliance with a polymer blanket. That method includes positioning the polymer blanket against a polymer surface of the electrical appliance and ultrasonically joining the polymer blanket to that surface.

In accordance with still another aspect of the present invention a method is provided for securing a polymer blanket to the polymer tub of a dishwasher. That method includes positioning the polymer blanket on the tub and ultrasonically joining the polymer blanket to the tub.

In accordance with yet another aspect of the present invention, a mechanical device is provided. The mechanical device comprises a mechanical component and a polymer insulator ultrasonically joined to a polymer wall of the mechanical device and at least partially enclosing the mechanical component. More specifically, an electrical appliance is provided. The electrical appliance comprises a mechanical device and a polymer insulator ultrasonically joined to a polymer wall of the electrical appliance and at least partially enclosing the mechanical component. Still more specifically, the invention includes a dishwasher. That dishwasher comprises a housing, a polymer tub held in the housing, a pump carried on the housing for circulating water to the tub and a polymer insulator ultrasonically joined to the tub.

In the following description there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of the specification, illustrates several aspects of the present invention, and together with the description serves to explain certain principles of the invention. In the drawing:

FIG. 1 is a schematical view in partially cutaway perspective of a dishwasher incorporating a polymer insulator ultrasonically joined to a wall of the tub of that dishwasher; and

FIG. 2 is a detailed cross sectional view showing the ultrasonic joining of a polymer insulator to the tub wall.

Reference will now be made in detail to the present preferred embodiment of the invention, an example of which is illustrated in the accompanying drawing.

### DETAILED DESCRIPTION AND PREFERRED EMBODIMENT OF THE INVENTION

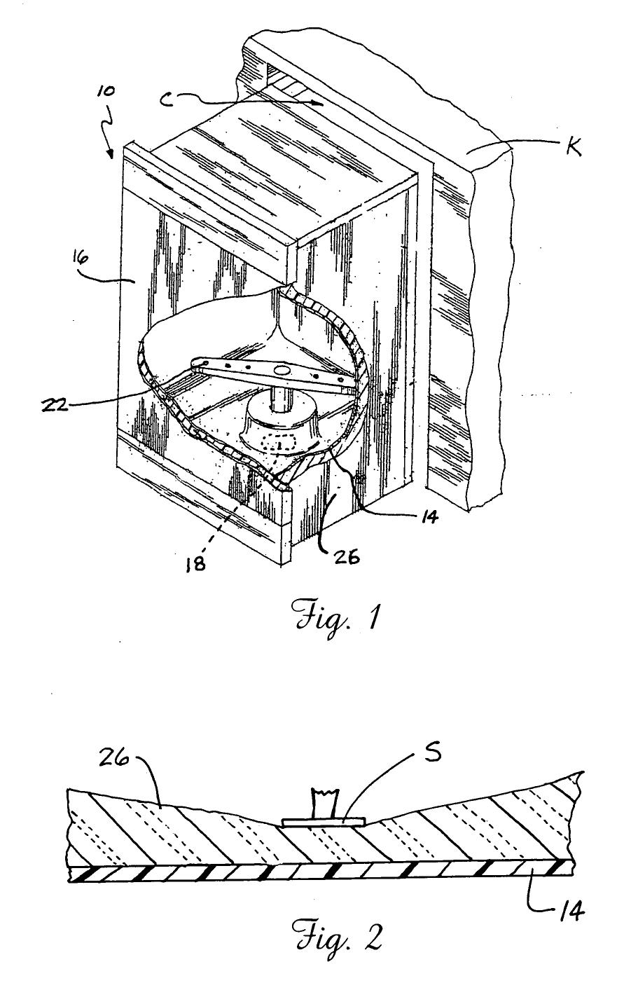

Reference is now made to FIG. 1 showing a dishwasher 10. The dishwasher 10 includes a housing or cabinet including a washing chamber or tub 14 closed by a door 16. The tub 14 is constructed from a polymer material in a manner well known in the art. The door 16 may be opened in order to gain access to the tub 14 into which dishes are placed for washing. The dishwasher 10 is an under-the-counter design suitable for insertion and mounting in a cavity C formed in a kitchen cabinet K.

The dishwasher 10 includes a circulation pump 18. The circulation pump circulates fluid, such as wash water, from a supply line to a washing nozzle 22 provided in the tub 14. The washing nozzle 22 directs the fluid stream against the dishes held in the tub 14 so as to scrub and lift food and drink residue from the dishes and provide the desired cleaning action. A drain line (not shown) discharges fluid entrained with food and drink residue and debris from the tub 14.

An insulation blanket 26 of thermoplastic material extends around the tub 14. The thermoplastic material of the insulation blanket, polymer blanket or insulator 26 is selected, for example, from a group of fibers consisting of polyester, polyolefin, polyethylene, rayon, nylon, acrylic, hemp, kenaf, cotton and combinations thereof. In one particularly useful embodiment, the acoustical insulation blanket 26 is composed of polyester staple fibers and polyester bicomponent fibers. These fibers have distinct diameters of between about 8.0-50.0 microns and distinct lengths of between about 0.5 and 3.0 inches. It should be appreciated, however, that the blanket may also include meltblown microfibers, fiberglass fibers, and/or other mineral or organic fibers if desired.

In accordance with the present invention, the polymer blanket 26 is secured to the tub 14 by first positioning the polymer blanket against a surface of the tub. Next is the ultrasonic joining of the polymer blanket 26 to the surface of the tub 14. The ultrasonic joining may be completed by welding, staking or inserting.

For purposes of this document welding includes spot welding and is defined as the process of generating melt of the polymer blanket material at the interface with the tub 14. When ultrasonic vibrations stop, the molten material solidifies and a weld is achieved. Ultrasonic welding allows fast, clean assembly without the use of consumables. “Staking” means the process of melting and reforming a thermoplastic stud to mechanically lock the polymer blanket 26 to the surface of the tub 14. Short cycle times, tight assemblies, good appearance of final assembly and elimination of consumables are possible with this technique. “Inserting” means embedding a metal component such as an insulator mounting ear carried on the tub into the polymer blanket material. High strength, reduced molding cycles and rapid installation with no stress buildup are some of the advantages of this process.

The ultrasonic joining is performed utilizing state of the art equipment including, for example, the Model H520 power supply with the Model CV52 hand gun manufactured by Sonics & Materials, 53 Church Hill Road, Newtown, Conn. 06470. The ultrasonic joining is completed at a frequency of between about 20 to about 40 kHz and a pressure that is typically between about 35 and about 65 psi. More specifically, the pressure used varies with the thickness and density of the insulation blanket 26. For low density, thin insulation, a pressure of about 35 psi is adequate. For thicker, heavier density insulation a higher pressure of about 65 psi is usually adequate. This amount of force may easily be applied by hand.

More specifically, the process involves positioning the polymer blanket 26 against the polymer surface of the mechanical device, in this illustrated instance the tub 14. With the polymer blanket 26 in place, the horn or sonitrode 5 of the ultrasonic joining machine is pressed against the polymer blanket 26 and tub 14 with the desired force to complete the joining operation (see FIG. 2). The polymer blanket 26 and tub 14 are then subjected to ultrasonic vibrations usually at a frequency of 20, 30 or 40 kHz and the joining is completed typically in less than one second.

### EXAMPLE 1

A polymer fiber acoustic insulation was attached to the tub of a dishwasher. The insulation was ½ inch thick and approximately 17 grams/ft² in weight. First the insulation was positioned against the surface of the polymer tub. The horn or sonitrode of the ultrasonic joining machine was then pressed against the insulation and tub at a pressure of approximately 35 psi. The tip of the sonitrode was a flat circle about 2 inch in diameter. With the insulation compressed, the ultrasonics were activated for 1.0 seconds at 75% power on a 500 watt power source. Attachments can be made at higher power settings and shorter time durations if desired.

The use of ultrasonics to attach the polymer blanket or insulator 26 offers cost savings to the manufacturer by eliminating a need for mechanical and/or adhesive fasteners. In addition, there is no waste involved. Further, ultrasonic joining is more visually appealing especially when compared to the use of tapes and adhesives. The present process or method may be used for substantially any application involving the attachment or securing of a polymer insulation, either acoustic or thermal, to a polymer surface.

The foregoing description of the preferred embodiment of the invention has been presented for purposes of illustration and description. It is not intended to be exhaustive or to limit the invention to the precise form disclosed. Obvious modifications or variations are possible in light of the above teachings. For example, the polymer blanket or insulator 26 may include a facing layer and/or a skin of relatively high density on one or both faces. Further, the blanket 26 may include a pad of vibration barrier insulation material (e.g. asphalt) on the top face, the bottom face and/or between layers.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed

1. A method of securing a polymer blanket to a mechanical device, comprising:
positioning said polymer blanket against a polymer surface of said mechanical device; and
ultrasonically joining said polymer blanket to said surface.

2. The method of claim 1, including completing said ultrasonic joining at a frequency of between about 20 to about 40 kHz and a pressure of between about 35 and about 65 psi.

3. The method of claim 1 wherein said ultrasonic joining is by welding.

4. The method of claim 1 wherein said ultrasonic joining is by staking.

5. The method of claim 1, wherein said ultrasonic joining is by inserting.

6. A method of insulating an electrical appliance with a polymer blanket, comprising:
positioning said polymer blanket against a polymer surface of said electrical appliance; and
ultrasonically joining said polymer blanket to said surface.

7. The method of claim 6, including completing said ultrasonic joining at a frequency of between about 20 to about 40 kHz and a pressure of between about 35 and about 65 psi.

8. The method of claim 6 wherein said ultrasonic joining is by welding.

9. The method of claim 6 wherein said ultrasonic joining is by staking.

10. The method of claim 6, wherein said ultrasonic joining is by inserting.

11. A method of securing a polymer blanket to a tub of a dishwasher, comprising:
positioning said polymer blanket on said tub; and
ultrasonically joining said polymer blanket to said tub.

12. The method of claim 11, including completing said ultrasonic joining at a frequency of between about 20 to about 40 kHz and a pressure of between about 35 and about 65 psi.

13. The method of claim 11 wherein said ultrasonic joining is by welding.

14. The method of claim 11 wherein said ultrasonic joining is by staking.

15. The method of claim 11, wherein said ultrasonic joining is by inserting.

16. A mechanical device, comprising:
a mechanical component; and
a polymer insulator ultrasonically joined to a polymer wall of said mechanical device and at least partially enclosing said mechanical component.

17. An electrical appliance, comprising:
a mechanical component; and
a polymer insulator ultrasonically joined to a polymer wall of said electrical appliance and at least partially enclosing said mechanical component.

18. A dishwasher, comprising:
a housing;
a tub held in said housing;
a pump carried on said housing for circulating water to said tub; and
a polymer insulator ultrasonically joined to said tub.
